(19) United States
(12) Patent Application Publication
(10) Pub. No.: US 2023/0322049 A1
(43) Pub. Date: Oct. 12, 2023

(54) VEHICLE CABIN AND RECHARGEABLE ENERGY STORAGE SYSTEM COOLING

(71) Applicant: GM GLOBAL TECHNOLOGY OPERATIONS LLC, DETROIT, MI (US)

(72) Inventors: Jacob Wright, Grosse Pointe Woods, MI (US); Srinivasa Rao Vaddiraju, Troy, MI (US); David O'Rourke, Shelby Twp., MI (US)

(21) Appl. No.: 17/714,289

(22) Filed: Apr. 6, 2022

(51) Int. Cl. B60H 1/32

(52) U.S. Cl. CPC B60H 1/323

(57) ABSTRACT

A heating, ventilation and air conditioning (HVAC) system of a vehicle includes a main compressor positioned along a refrigerant circuit circulating a flow of refrigerant therethrough. A chiller is located along the refrigerant circuit and is fluidly connected to a rechargeable energy storage system to cool the rechargeable energy storage system. A chiller outlet passage directs the flow of refrigerant from the chiller toward the main compressor, and an evaporator is located along the refrigerant circuit in a fluidly parallel relationship with the chiller. The evaporator is configured to cool a vehicle cabin. An evaporator outlet passage directs the flow of refrigerant from the evaporator toward the main compressor, and an auxiliary compressor is located along the evaporator outlet passage between the evaporator and the main compressor.

### INTRODUCTION

The subject disclosure relates to electric vehicles, and more precisely to cooling of a cabin and a rechargeable energy storage system (RESS) of an electric vehicle.

A typical RESS, also known by the term a “battery pack” or other similar nomenclature has an optimal performance within a narrow temperature range. When operating conditions fall outside of this range at an upper end, the RESS is cooled via a chiller connected to the RESS, circulating a flow of coolant therethrough.

The vehicle cabin cooling system and the chiller are linked such that they reside in the same refrigerant circuit. During certain electric vehicle (EV) operating events, such as, high trailering on mountains or top speed or racing events, the RESS generates significant heat, and the high load operation of the chiller to cool the RESS reduces performance of the of the vehicle cabin cooling system. It is desired to provide the needed RESS cooling in such events, while maintaining vehicle cabin cooling.

### SUMMARY

In one embodiment, a heating, ventilation and air conditioning (HVAC) system of a vehicle includes a main compressor positioned along a refrigerant circuit circulating a flow of refrigerant therethrough. A chiller is located along the refrigerant circuit and is fluidly connected to a rechargeable energy storage system to cool the rechargeable energy storage system. A chiller outlet passage directs the flow of refrigerant from the chiller toward the main compressor, and an evaporator is located along the refrigerant circuit in a fluidly parallel relationship with the chiller. The evaporator is configured to cool a vehicle cabin. An evaporator outlet passage directs the flow of refrigerant from the evaporator toward the main compressor, and an auxiliary compressor is located along the evaporator outlet passage between the evaporator and the main compressor.

Additionally or alternatively, in this or other embodiments a bypass passage extends from the evaporator outlet passage between the evaporator and the auxiliary compressor to allow the flow of refrigerant to selectably bypass the auxiliary compressor.

Additionally or alternatively, in this or other embodiments a bypass valve controls the flow of refrigerant through the bypass passage.

Additionally or alternatively, in this or other embodiments an evaporator expansion valve is positioned upstream of the evaporator to control the flow of refrigerant through the evaporator.

Additionally or alternatively, in this or other embodiments a chiller expansion valve is positioned upstream of the evaporator to control the flow of refrigerant through the evaporator.

Additionally or alternatively, in this or other embodiments a coolant circuit fluidly connects the chiller and the rechargeable energy storage system. The coolant circuit circulates a flow of coolant therethrough to absorb thermal energy from the rechargeable energy storage system and transfer the thermal energy to the flow of refrigerant at the chiller.

Additionally or alternatively, in this or other embodiments a controller controls operation of the HVAC system.

Additionally or alternatively, in this or other embodiments when the HVAC system is operated in the first mode, the controller operates to direct the flow of refrigerant through the evaporator, bypassing the chiller, and direct the flow of refrigerant from the evaporator along a bypass passage bypassing the auxiliary compressor.

Additionally or alternatively, in this or other embodiments when the HVAC system is operated in a second mode, the controller operates to direct the flow of refrigerant through both of the evaporator and the chiller, and direct the flow of refrigerant from the evaporator along the bypass passage.

Additionally or alternatively, in this or other embodiments when the HVAC system is operated in a third mode, the controller operates to direct the flow of refrigerant through both of the evaporator and the chiller, and direct the flow of refrigerant from the evaporator through the auxiliary compressor.

Additionally or alternatively, in this or other embodiments when the HVAC system is operated in a fourth mode, the controller operates to direct the flow of refrigerant through the chiller and main compressor without directing the refrigerant flow through the evaporator and auxiliary compressor.

In another embodiment, a method of operating a heating ventilation and air conditioning (HVAC) system includes directing a flow of refrigerant along a refrigerant circuit from a main compressor a main compressor. The flow of refrigerant is selectably directed through one or more of a chiller positioned along the refrigerant circuit downstream of the main compressor, the chiller fluidly connected to a rechargeable energy storage system to cool the rechargeable energy storage system, or through an evaporator positioned along the refrigerant circuit in a fluidly parallel relationship with the chiller. The evaporator is configured to cool a vehicle cabin. The selection is based on a detected temperature of the rechargeable energy storage system. The flow of refrigerant is selectably directed from the evaporator through an auxiliary compressor positioned along an evaporator outlet passage between the evaporator and the main compressor. The selection is based on the detected temperature of the rechargeable energy storage system.

Additionally or alternatively, in this or other embodiments the temperature of the rechargeable energy storage system is compared to a predetermined threshold range.

Additionally or alternatively, in this or other embodiments when the temperature of the rechargeable energy storage system is below the threshold range, the flow of refrigerant is directed through the evaporator, bypassing the chiller, and the flow of refrigerant from the evaporator is directed along a bypass passage bypassing the auxiliary compressor.

Additionally or alternatively, in this or other embodiments when the temperature of the rechargeable energy storage system is within the threshold range, the flow of refrigerant is directed through both of the evaporator and the chiller, and the flow of refrigerant from the evaporator is directed along the bypass passage.

Additionally or alternatively, in this or other embodiments when the temperature of the rechargeable energy storage system exceeds the threshold range, the flow of refrigerant is directed through both of the evaporator and the chiller, and the flow of refrigerant from the evaporator is directed through the auxiliary compressor.

Additionally or alternatively, in this or other embodiments the threshold range is 35 degrees Celsius to 40 degrees Celsius.

Additionally or alternatively, in this or other embodiments the flow of refrigerant through the auxiliary compressor is controlled via a bypass valve.

Additionally or alternatively, in this or other embodiments flow of refrigerant through the evaporator is controlled via an evaporator expansion valve disposed upstream of the evaporator.

Additionally or alternatively, in this or other embodiments a flow of coolant is urged through a coolant circuit fluidly connecting the chiller and the rechargeable energy storage system to absorb thermal energy from the rechargeable energy storage system and transfer the thermal energy to the flow of refrigerant at the chiller.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic illustration of an embodiment of a heating, ventilation and air conditioning (HVAC) system of a vehicle;

FIG. 2 is a schematic illustration of operation of an embodiment of an HVAC system in a first mode;

FIG. 3 is a schematic illustration of operation of an embodiment of an HVAC system in a second mode;

FIG. 4. is a schematic illustration of operation of an embodiment of an HVAC system in a third mode;

FIG. 5 is a schematic illustration of operation of an embodiment of an HVAC system in a fourth mode; and

FIG. 6 is a schematic illustration of a method of controlling operation of an HVAC system.

### DETAILED DESCRIPTION

The following description is merely exemplary in nature and is not intended to limit the present disclosure, its application or uses. It should be understood that throughout the drawings, corresponding reference numerals indicate like or corresponding parts and features.

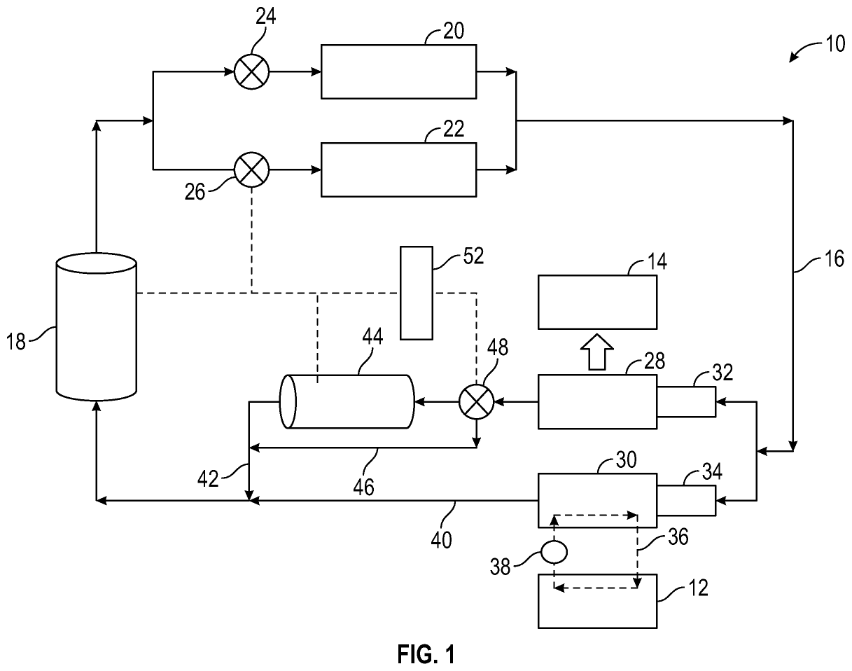

In accordance with an exemplary embodiment, an illustration of a heating, ventilation, and air conditioning (HVAC) system 10 for a vehicle is shown in FIG. 1. The vehicle includes a rechargeable energy storage system (RESS) 12, such as electric rechargeable traction batteries, electric double-layer capacitors or flywheel energy storage. The HVAC system 10 is utilized to heat and cool both a vehicle cabin 14 and the RESS 12 as needed.

The HVAC system 10 includes a refrigerant circuit 16 through which a flow of refrigerant is circulated. The refrigerant circuit 16 includes a main compressor 18, which directs compressed refrigerant toward one or more of a cabin heater heat exchanger (CHX) 20 and an outside heat exchanger (OHX) 22, which are arranged in a fluidly parallel relationship. A CHX valve 24 is located upstream of the CHX 20 and an OHX valve 26 is located upstream of the OHX 22. Operation of the CHX valve 24 and the OHX valve 26 selectably directs the flow of refrigerant through the CHX 20 or OHX 22, depending on whether heating or cooling of the vehicle cabin 14 is desired. While in the embodiment of FIG. 1 the CHX valve 24 and the CHX valve 26 are located upstream of the CHX 20 and the OHX 22, respectively, one skilled in the art will readily appreciate that other valve arrangements may be utilized to selectably direct the flow of refrigerant to the CHX 20 and/or the OHX 22. For example, in some embodiments the CHX valve 24 and the OHX valve 26 may be located downstream of the CHX 20 and the OHX 22, respectively.

An evaporator 28 and a chiller 30 are located along the refrigerant circuit 16 downstream of the CHX 20 and OHX 22. The evaporator 28 and the chiller 30 are arranged in a fluidly parallel relationship, with an evaporator expansion valve (EEXV) 32 and a chiller expansion valve (CEXV) 34 located upstream of the evaporator 28 and the chiller 30, respectively, to control the flow of refrigerant through the evaporator 28 and chiller 30. When the HVAC system 10 is operated in a cooling mode, the flow of refrigerant through the evaporator 28 is utilized to cool the vehicle cabin 14, while the flow of refrigerant through the chiller 30 is utilized to cool the RESS 12. In one embodiment, a coolant circuit 36 connects the chiller 30 to the RESS 12 and a flow of coolant, such as water or glycol, is circulated through the coolant circuit 36. The flow of coolant is cooled at the chiller 30 by the flow of refrigerant, and then absorbs thermal energy at the RESS 12 to cool the RESS 12. The warmed flow of coolant is then circulated back to the chiller 30. In some embodiments, a coolant pump 38 circulates the flow of coolant through the coolant circuit 36.

The flow of refrigerant exits the chiller 30 via a chiller outlet passage 40 before being returned to the main compressor 18. Similarly, the flow of refrigerant exits the evaporator 28 along an evaporator outlet passage 42 before returning to the main compressor 18. An auxiliary compressor 44 is located along the evaporator outlet passage 42. Further, a bypass passage 46 extends around the auxiliary compressor 44 and allows the flow of refrigerant to selectably bypass the auxiliary compressor 44 via operation of, for example, a bypass valve 48 located upstream of the auxiliary compressor 44. A controller 52 is operably connected to components of the HVAC system 10, such as the main compressor 18, the auxiliary compressor 44, the CHX valve 24, the OHX valve 26, the EEXV 32, the CEXV 34, and the bypass valve 48 to control operation of the HVAC system 10. For the sake of clarity not all controller 52 connections are illustrated. As will be described in more detail herein, the HVAC system 10 may be operated in multiple modes depending on the cooling requirements of the vehicle cabin 14 and the RESS 12.

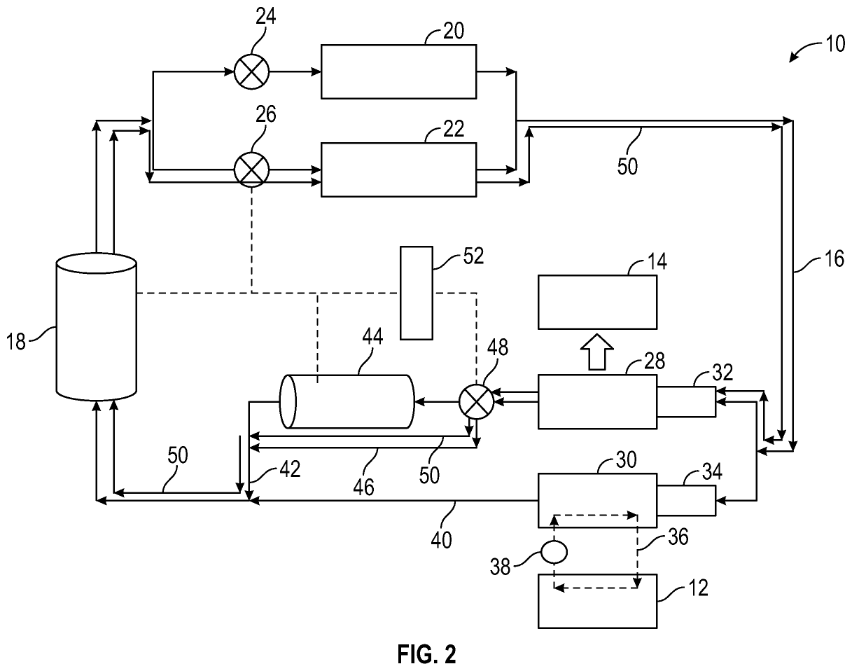

Referring now to FIG. 2, in a first mode the HVAC system 10 is operated to cool the vehicle cabin 14 only when, for example, cooling of the RESS 12 is not needed. In this first mode, the flow of refrigerant, shown as 50, exits the main compressor 18 and is directed through the OHX 22. The controller 52 commands opening of the EEXV 32 and closing of the CEXV 34, thus directing the flow of refrigerant 50 through the evaporator 28; bypassing the chiller 30. The controller 52 commands operation of the bypass valve 48 to direct the flow of refrigerant 50 through the bypass passage 46, bypassing the auxiliary compressor 44. The flow of refrigerant 50 is then returned to the main compressor 18.

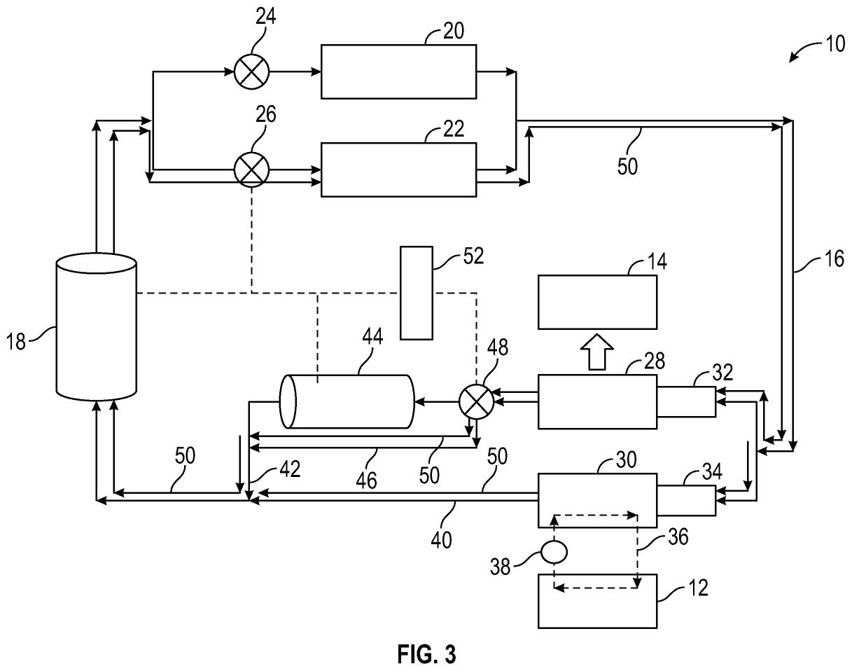

In a second mode illustrated in FIG. 3, the HVAC system 10 is operated to cool both the vehicle cabin 14 and the RESS 12 when the RESS 12 has a temperature within a predetermined temperature threshold range, which is for example between 35 degrees Celsius and 40 degrees Celsius. In the second mode, the controller 52 commands opening of both the EEXV 32 and the CEXV 34 to direct the flow of refrigerant 50 through both of the evaporator 28 and the chiller 30 to cool both the vehicle cabin 14 and the RESS 12. The controller 52 commands operation of the bypass valve 48 to direct the flow of refrigerant 50 through the bypass passage 46, bypassing the auxiliary compressor 44. The flow of refrigerant 50 is then returned to the main compressor 18.

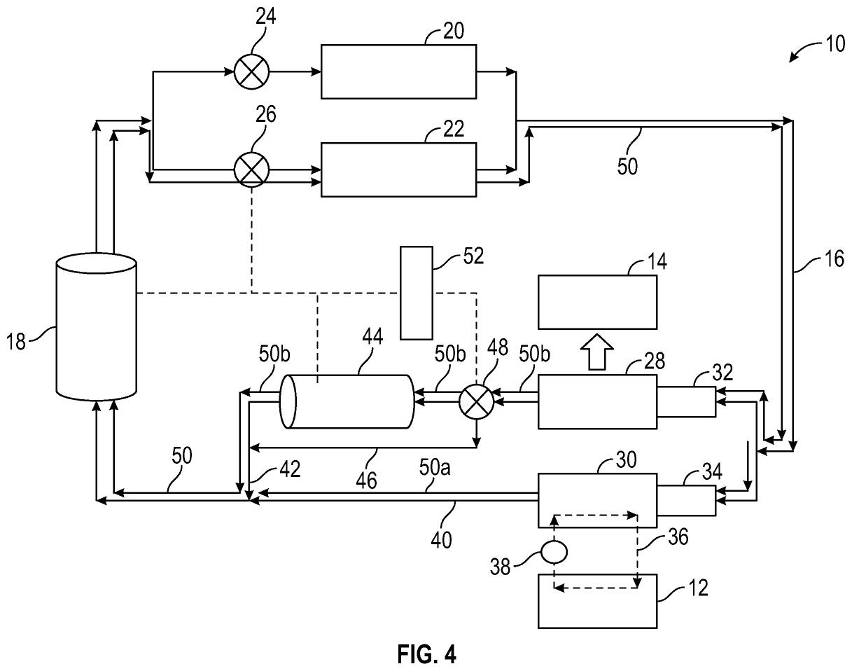

A third mode of operation of the HVAC system 10 is illustrated in FIG. 4. The third mode is utilized when both vehicle cabin 14 and RESS 12 temperature exceeds the threshold range, for example, greater than 40 degree Celsius. When the RESS 12 temperature exceeds the threshold range and cabin cooling is also requested, the combined thermal load from chiller 30 and evaporator 28 increases significantly and the main compressor 18, owing to its limitations, may not circulate enough refrigerant 50 through the HVAC system 10 to extract the higher thermal loads, and still maintain a required pressure of, for example, about 300 kPa in the evaporator. This results in the RESS 12 not being sufficiently cooled, raising its temperature going beyond the limits. To overcome the limited RESS 12 thermal heat removal, an auxiliary compressor 44 can be used. In this mode, the controller 52 operates the bypass valve 48 to direct the flow of refrigerant 50b exiting the evaporator 28 through the operating auxiliary compressor 44 to increase the pressure of the refrigerant 50b. This results in the operation of the HVAC system 10, such that the auxiliary compressor 44 will raise the refrigerant pressure, for example from 300 kPa to 600 kPa. The CEXV 34 will be operated in such a way that it results in refrigerant pressure exiting the chiller 30 at, for example, 600 kPa. The refrigerant 50 at 600 kPa will be denser as compared to 300 kPa, and with 600 kPa at the suction side of main compressor 18, the main compressor 18 will be able to move more refrigerant through the HVAC system 10. This results in an increased flow of refrigerant 50b to remove higher amounts of thermal load, while still maintaining the required pressure of ˜300 kPa at evaporator 28 to provide comfortable cabin cooling.

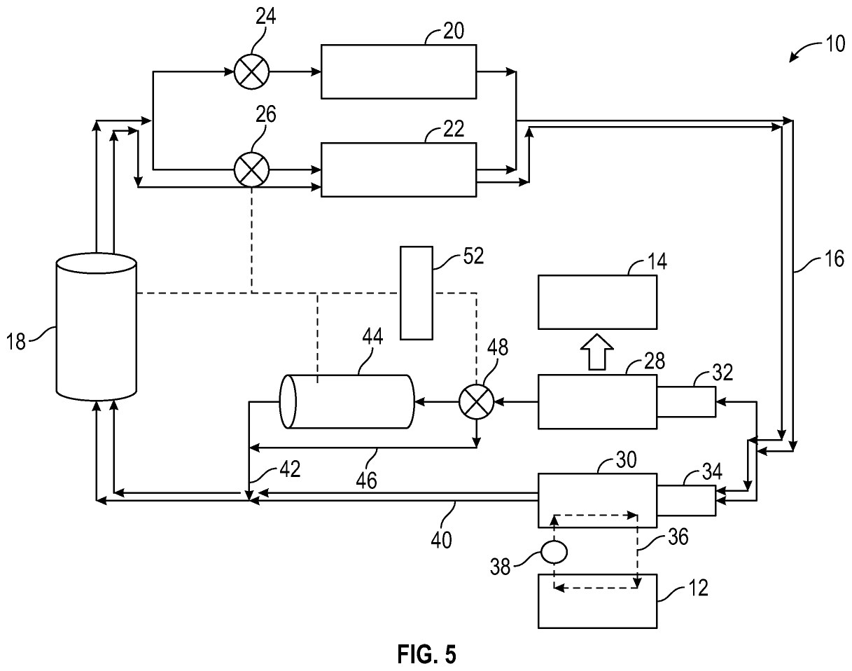

In a fourth mode illustrated in FIG. 5, the HVAC system 10 is operated to cool only the RESS 12, when the RESS 12 has a temperature above a predetermined temperature threshold range, for example, greater than 40 degree Celsius. In this mode, the cabin cooling is not commanded. In the fourth mode, the controller 52 commands opening of CEXV 34 and closing of EEXV 32 to direct the flow of refrigerant 50 through only chiller 30 to cool only the RESS 12. The flow of refrigerant 50 is then returned to the main compressor 18.

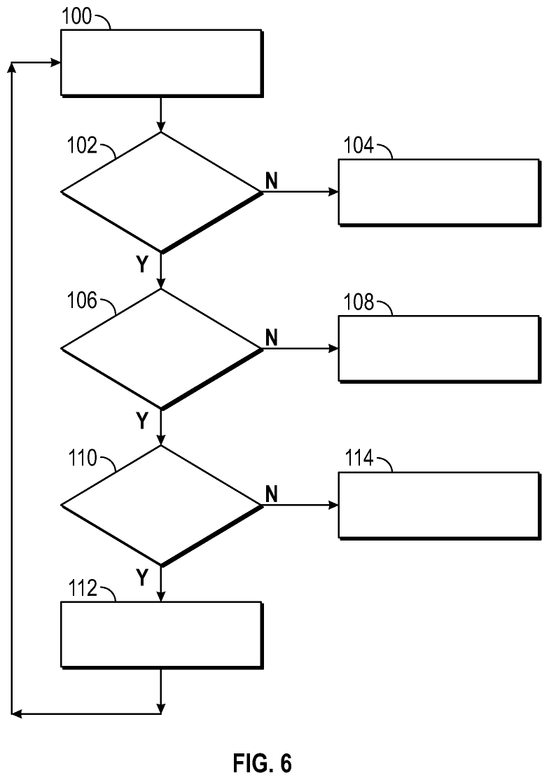

Referring now to FIG. 6, illustrated is an exemplary method of operation of the HVAC system 10, specifically operation of the auxiliary compressor 44 and the bypass valve 48. At block 100, the controller 52 receives information regarding the RESS 12 temperature from, for example, temperature sensors (not shown) at the RESS 12. At block 102, it is determined if the RESS 12 temperature is greater than the low end of the threshold range. At block 104, if the RESS 12 temperature is not greater than the lower end of the threshold range, no action is needed to cool the RESS 12 so the HVAC system 10 is operated in the first mode of FIG. 2. At block 106, the controller 52 determines if the RESS 12 temperature exceeds the threshold range. At block 108, if the RESS temperature does not exceed the threshold range, the HVAC system 10 is operated in the second mode of FIG. 3. The flow of refrigerant 50 is directed through both the evaporator 28 and the chiller 30, and the bypass valve 48 is operated to bypass the auxiliary compressor 44 so that the flow of refrigerant is directed to the main compressor 18 upon leaving the evaporator 28. This method is continually repeated or periodically repeated during operation of the HVAC system 10.

In block 110, if the RESS 12 temperature exceeds the threshold the controller 52 determines if vehicle cabin 14 cooling is requested. At block 112, if vehicle cabin 14 cooling is requested, the HVAC system 10 is operated in a third mode, and the controller 52 operates the bypass valve 48 to direct the flow of refrigerant 50b leaving the evaporator 28 through the auxiliary compressor 44 to increase the pressure of the flow of refrigerant 50b prior to going into the main compressor 18. Alternatively, at block 114, if vehicle cooling is not requested, the HVAC system 10 is operated in a fourth mode, the controller 52 commands opening of CEXV 34 and closing of EEXV 32 to direct the flow of refrigerant 50 through only chiller to cool only the RESS 12. The flow of refrigerant 50 is then returned to the compressor.

Addition of the auxiliary compressor 44 and the bypass valve 48 along the evaporator outlet passage 42 greatly improves cooling capacity of the chiller 30 to cool the RESS 12, while also providing effective vehicle cabin 14 cooling even when the RESS 12 temperature is high.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A heating, ventilation and air conditioning (HVAC) system of a vehicle comprising:
a main compressor disposed along a refrigerant circuit circulating a flow of refrigerant therethrough;
a chiller disposed along the refrigerant circuit fluidly connected to a rechargeable energy storage system to cool the rechargeable energy storage system;
a chiller outlet passage to direct the flow of refrigerant from the chiller toward the main compressor;
an evaporator disposed along the refrigerant circuit in a fluidly parallel relationship with the chiller, the evaporator configured to cool a vehicle cabin;
an evaporator outlet passage to direct the flow of refrigerant from the evaporator toward the main compressor; and
an auxiliary compressor disposed along the evaporator outlet passage between the evaporator and the main compressor.

2. The HVAC system of claim 1, further comprising a bypass passage extending from the evaporator outlet passage between the evaporator and the auxiliary compressor to allow the flow of refrigerant to selectably bypass the auxiliary compressor.

3. The HVAC system of claim 2, further comprising a bypass valve to control the flow of refrigerant through the bypass passage.

4. The HVAC system of claim 1, further comprising an evaporator expansion valve disposed upstream of the evaporator to control the flow of refrigerant through the evaporator.

5. The HVAC system of claim 1, further comprising a chiller expansion valve disposed upstream of the evaporator to control the flow of refrigerant through the evaporator.

6. The HVAC system of claim 1, further comprising a coolant circuit fluidly connecting the chiller and the rechargeable energy storage system, the coolant circuit circulating a flow of coolant therethrough to absorb thermal energy from the rechargeable energy storage system and transfer the thermal energy to the flow of refrigerant at the chiller.

7. The HVAC system of claim 1, further comprising a controller to control operation of the HVAC system.

8. The HVAC system of claim 7, wherein when the HVAC system is operated in a first mode, the controller operates to:
direct the flow of refrigerant through the evaporator, bypassing the chiller; and
direct the flow of refrigerant from the evaporator along a bypass passage bypassing the auxiliary compressor.

9. The HVAC system of claim 7, wherein when the HVAC system is operated in a second mode, the controller operates to:
direct the flow of refrigerant through both of the evaporator and the chiller; and
direct the flow of refrigerant from the evaporator along a bypass passage bypassing the auxiliary compressor.

10. The HVAC system of claim 7, wherein when the HVAC system is operated in a third mode, the controller operates to:
direct the flow of refrigerant through both of the evaporator and the chiller; and
direct the flow of refrigerant from the evaporator through the auxiliary compressor.

11. The HVAC system of claim 7, wherein when the HVAC system is operated in a fourth mode, the controller operates to: direct the flow of refrigerant through the chiller and main compressor without directing the refrigerant flow through the evaporator and auxiliary compressor.

12. A method of operating a heating ventilation and air conditioning (HVAC) system, comprising:
directing a flow of refrigerant along a refrigerant circuit from a main compressor;
selectably directing the flow of refrigerant through one or more of:
a chiller disposed along the refrigerant circuit downstream of the main compressor, the chiller fluidly connected to a rechargeable energy storage system to cool the rechargeable energy storage system; or
an evaporator disposed along the refrigerant circuit in a fluidly parallel relationship with the chiller, the evaporator configured to cool a vehicle cabin, the selection based on a detected temperature of the rechargeable energy storage system; and
selectably directing the flow of refrigerant from the evaporator through an auxiliary compressor disposed along an evaporator outlet passage between the evaporator and the main compressor, the selection based on the detected temperature of the rechargeable energy storage system.

13. The method of claim 12, wherein the temperature of the rechargeable energy storage system is compared to a predetermined threshold range.

14. The method of claim 13, wherein when the temperature of the rechargeable energy storage system is below the threshold range, the flow of refrigerant is directed through the evaporator, bypassing the chiller, and the flow of refrigerant from the evaporator is directed along a bypass passage bypassing the auxiliary compressor.

15. The method of claim 13, wherein when the temperature of the rechargeable energy storage system is within the threshold range, the flow of refrigerant is directed through both of the evaporator and the chiller, and the flow of refrigerant from the evaporator is directed along a bypass passage bypassing the auxiliary compressor.

16. The method of claim 13, wherein when the temperature of the rechargeable energy storage system exceeds the threshold range, the flow of refrigerant is directed through both of the evaporator and the chiller, and the flow of refrigerant from the evaporator is directed through the auxiliary compressor.

17. The method of claim 13, wherein the threshold range is 35 degrees Celsius to 40 degrees Celsius.

18. The method of claim 12, further comprising controlling the flow of refrigerant through the auxiliary compressor via a bypass valve.

19. The method of claim 12, further comprising controlling the flow of refrigerant through the evaporator via an evaporator expansion valve disposed upstream of the evaporator.

20. The method of claim 12, further comprising urging a flow of coolant through a coolant circuit fluidly connecting the chiller and the rechargeable energy storage system to absorb thermal energy from the rechargeable energy storage system and transfer the thermal energy to the flow of refrigerant at the chiller.
